(19) United States
(12) Patent Application Publication
(10) Pub. No.: US 2025/0272620 A1
(43) Pub. Date: Aug. 28, 2025

(54) RESOURCES MANAGER FOR A SECURED ADVANCED DRIVER ASSISTANCE SYSTEM (ADAS) PERCEPTION SYSTEM

(71) Applicant: QUALCOMM Incorporated, San Diego, CA (US)

(72) Inventors: Jean-Philippe MONTEUUIS, Northborough, MA (US); Jonathan PETIT, Wenham, MA (US); Senthil Kumar YOGAMANI, Headford (IE); Varun RAVI KUMAR, San Diego, CA (US); Mohammad Raashid ANSARI, Saugus, MA (US); Cong CHEN, San Diego, CA (US)

(21) Appl. No.: 18/587,725

(22) Filed: Feb. 26, 2024

(51) Int. Cl. G06N 20/20; G06F 9/50

(52) U.S. Cl. CPC G06N 20/20; G06F 9/5027

(57) ABSTRACT

Techniques and systems are provided for managing computing resources, comprising: obtaining resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and disabling the ML model based on a comparison between the resource usage information to a first threshold.

### FIELD

The present disclosure generally relates to resource management for an advanced driver assistance system (ADAS). For example, aspects of the present disclosure are related to systems and techniques for a resources manager for an ADAS perception system.

### BACKGROUND

Many devices or systems (e.g., autonomous vehicles, such as autonomous and semi-autonomous vehicles, drones or unmanned aerial vehicles (UAVs), mobile robots, mobile devices such as mobile phones, extended reality (XR) devices, and other suitable devices or systems) include multiple sensors to gather information about an environment. Such devices or systems may also include processing systems to process the sensor information for various purposes, such as route planning, navigation, collision avoidance, etc.

One example of a processing system is an ADAS for an autonomous or semi-autonomous vehicle. In some cases, ADAS systems, like with all processing systems, may be subject to attack. Therefore, techniques to mitigate possible attacks may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for managing computing resources is provided. The apparatus includes at least one memory and a processor system (e.g., configured in circuitry) coupled to the at least one memory. The processor system is configured to: obtain resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and disable the ML model based on a comparison between the resource usage information to a first threshold.

In another example, a method for managing computing resources is provided. The method includes: obtaining resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and disabling the ML model based on a comparison between the resource usage information to a first threshold.

As another example, non-transitory computer-readable medium is provided. The non-transitory computer-readable medium includes that, when executed by a processor system, cause the processor system to: a obtain resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and disable the ML model based on a comparison between the resource usage information to a first threshold.

In another example, an apparatus for managing computing resources is provided. The apparatus includes: means for obtaining resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and means for disabling the ML model based on a comparison between the resource usage information to a first threshold.

In some aspects, the apparatus is, is part of, and/or includes a vehicle or a computing device or component of a vehicle (e.g., an autonomous vehicle), a camera, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus further includes a display for displaying one or more images, notifications, and/or other displayable data. In some aspects, the apparatuses described above can include one or more sensors (e.g., one or more inertial measurement units (IMUs)), such as one or more gyrometers, one or more accelerometers, any combination thereof, and/or other sensor for obtaining information about the environment, such as a lidar, radar, etc. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIGS. 1A and 1B are block diagrams illustrating a vehicle suitable for implementing various techniques described herein, in accordance with aspects of the present disclosure;

FIG. 1C is a block diagram illustrating components of a vehicle suitable for implementing various techniques described herein, in accordance with aspects of the present disclosure;

FIG. 1D illustrates an example implementation of a system-on-a-chip (SOC), in accordance with some examples;

FIG. 2A is a component block diagram illustrating components of an example vehicle management system, in accordance with aspects of the present disclosure;

FIG. 2B is a component block diagram illustrating components of another example vehicle management system, in accordance with aspects of the present disclosure;

FIG. 3A is a block diagram illustrating a perception system of an ADAS system having a common backbone, in accordance with aspects of the present disclosure;

FIG. 3B is a block diagram illustrating a perception system of an ADAS with separate backbones, in accordance with aspects of the present disclosure;

FIG. 4 is a flow diagram illustrating a technique for resources management for a perception system, in accordance with aspects of the present disclosure;

FIG. 5 is a flow diagram illustrating a process for managing computing resources, in accordance with aspects of the present disclosure;

FIG. 6 illustrates an example computing device architecture of an example computing device which can implement techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Generally, autonomous (e.g., semi-autonomous and/or fully autonomous) vehicles utilize various sensors to obtain information about an environment around the vehicle to help the vehicle navigate the environment. A processing system of the vehicle (referred to as an ego vehicle) may be used to process the information for one or more operations, such as localization, route planning, navigation, collision avoidance, among others. For example, in some cases, the sensor data may be obtained from the one or more sensor (e.g., one or more images captured from one or more cameras, depth information captured or determined by one or more radar and/or lidar sensors, etc.), transformed, and analyzed to detect objects by one or more perception systems.

A system that is not in a strictly controlled environment may be subject to attack from malicious actors. For instance, one or more attacks may target a perception system of an ADAS system, which may obtain data from sensors and process the obtained sensor data. Example attacks on perception systems may include projection attacks (e.g., where various signs, objects, patterns, etc. may be projected onto a surface on or near where a vehicle is travelling or directly onto a camera sensor of the vehicle, etc.), false signs (e.g., pedestrian with a stop sign shirt on, car with a yield sign, etc.), patch attacks (e.g., abstract patterns or false objects designed to fool image processing systems, radar/lidar reflectors/absorbers to confuse such sensors, etc.), and the like. In some cases, the perception system may include multiple sets of machine learning (ML) models (e.g., neural network models) for performing a variety of perception tasks, such as object detection, segmentation, depth estimation, object recognition, etc. The perception tasks may be any function that may be performed by a ML model that interprets sensor data to obtain information about the environment. As an example, a perception system may include an ensemble of one or more ML models for object detection as one ML model for object detection may perform better, for example, in the rain, while another ML model for object detection may perform better in city traffic, and so forth. Different perception tasks may have their own ensemble of one or more ML models to perform the perception task.

The perception system may also include a security system which may perform certain security tasks, such as attempting to detect different potential attacks in the obtained sensor data. Security tasks for the perception system may be functions performed by a ML model which may protect the operation of the perception system by detecting and/or mitigating attempts to manipulate, alter, deceive, or otherwise influence a normal operation of the perception system. Examples of security tasks can include patch detection, latency detection, and projection attack detection. Patch detection focuses on detecting, typically within a single image, abnormal geometrical patterns and abnormal color patterns within a cluster of pixels. The patch detection models may also monitor a consistency of the outputs generated by an object detection vision task across a set of images (e.g., video). For example, a traffic sign detected by the vision task should consistently be classified as a traffic sign and not be classified as something else (e.g., car). The detection across images should be consistent. In case of a loss of signal, the object (e.g., traffic sign) should be consistently detected later when an ego vehicle gets closer to the object. In some cases, an increase in latency for the perception system may result from a patch attack or projection attack. Other attack results can include scene or/and object misclassification, object misdirection, fake bounding box creating, abnormal depth estimation, and the like. For a single image, projection attack detection tasks may include the detection of heat on an object (e.g., heat from the projector light targeting a car), the detection of light source, detection of light-based raytracing, detection of projected abnormal color patterns based on a non-visible light spectrum (e.g., infra-red or ultra-violet). In some cases, detection across a set of images, may be performed in a manner similar to patch detection.

Different security tasks may be performed using different ensembles of one or more ML models. The security system and security tasks may run in parallel with the perception system and tasks. For example, an ADAS system may include one or more ensembles of functional ML models where each ensemble includes a set of functional ML models for performing a perception task. The functional ML models may be ML models that provide the functionality of the ADAS system, such as perception, navigation, path planning, etc. The ADAS system may also include one or more ensembles of security ML models where each ensemble includes a set of security ML models for performing a security task.

Generally, an ADAS system has a finite amount of computing resources, and these computing resources may be divided at least in part between the perception tasks and security tasks. In some cases, a resources manager for a secured ADAS perception system may be useful for managing and/or allocating limited computing resources. Computing resources may be resources of a computer used to operate, such as processing power, available memory, available storage, available bandwidth, energy consumption, etc.

Systems and techniques are described that provide resource management (e.g., a resource manager) for a secured ADAS perception system. In some cases, a resources manager can be used for managing and/or dividing computing resources among a set of ensembles of functional ML models and a set of ensembles of security ML models (e.g., neural network models or other type(s) of ML models). Computational resources (e.g., computing resources) may include limited resources that may be used to execute ML models such as available processing cycles, memory, storage, bandwidth, power consumption, thermal overhead, etc. The resources manager may allocate resources based on a resource usage and conditions of the environment and/or the ADAS system. For example, during a default state, the ML models of the set of ensembles of functional ML models and set of ensembles of security ML models may run concurrently and there are sufficient computing resources such that the ML models have sufficient computing resources to run. If an amount of computational resources used by the ML models (e.g., of the set of ensembles of functional ML models and set of ensembles of security ML models) exceeds a first threshold (e.g., based on a comparison of the computational resources used and a medium resource usage threshold) the resource manager may begin to selectively disable security ML models. For example, the resources manager may obtain resource usage information indicating an amount of computational resources used by ML models of the ensembles of functional ML models and the computational resources used by ML models of the ensembles of security ML models. The resources manager may compare the computational resources used (e.g., as indicated in the obtained resource usage information) against resource usage thresholds (e.g., medium resource usage threshold, first threshold, etc.). In some cases, specific thresholds of the resource usage thresholds may be set on a per computational resources basis.

In cases where the medium resource usage threshold is met, the resource manager may disable selected ML models from the set of ensembles of security ML models. Selecting ML models to disable may be performed on an ensemble level or for ML models within an ensemble. For example, when selecting ML models on an ensemble level, one or more ensembles of security ML models may be selected based on how relevant the security tasks performed by the ensemble or how high of a priority the security tasks performed by the ensemble are. ML models from the least relevant ensembles or lowest priority ensembles may be disabled. In some cases, all of the ML models from least relevant ensembles or lowest priority ensembles may be disabled. In other cases, all but one ML model from the least relevant ensembles or lowest priority ensembles may be disabled.

In some cases, relevance of an ML model may be based on a set of predetermined rules with respect to the ML models and these predetermined rules may be contextually based (e.g., based on contextual data). For example, during an ongoing attack, a first ML model which cannot detect the attack may be determined to be less relevant, while a second ML model which can detect the attack may be determined to be more relevant. Similarly, where perceptive tasks are limiting an amount of computing resources (e.g., due to a challenging environment), the first ML model may be determined to be more relevant as a type of attack detectable by the first ML model tends to be more common/more easily performed as compared to a type of attack detectable by the second ML model. As another example, when selecting ML models within an ensemble for disabling, the resources manager may obtain information about a relevance of a particular ML model, an amount of energy the ML model may be consuming, an amount of time used by the ML model for inference, and the like, and the resource manager may select ML to disable based on the obtained information.

In some cases, if the amount of computation resources used by the ML models (e.g., the set of ensembles of functional ML models and set of ensembles of security ML models) exceeds a second threshold (e.g., a high resource usage threshold) the resource manager may begin to selectively disable security ML models and/or functional ML models. In some cases, whether to disable security ML models, functional ML models, or both may be determined based on challenges faced by the ADAS system. In some cases, there may be functional challenges and security challenges. Functional challenges may be based on, for example, environmental conditions around the vehicle that may make perception more difficult, such as being in an environment with lots of objects to process, such as in a dense urban environment, traffic jam, inclement weather, etc. Security challenges may be based on an indication that the ADAS system is being attacked (e.g., an attack is occurring). A determination whether there is a functional challenge or security challenge that may be causing the increased use of computational resources may be used to determine whether to prioritize the set of ensembles of functional ML models or set of ensembles of security ML models, or to balance the sets of ensembles.

Various aspects of the application will be described with respect to the figures.

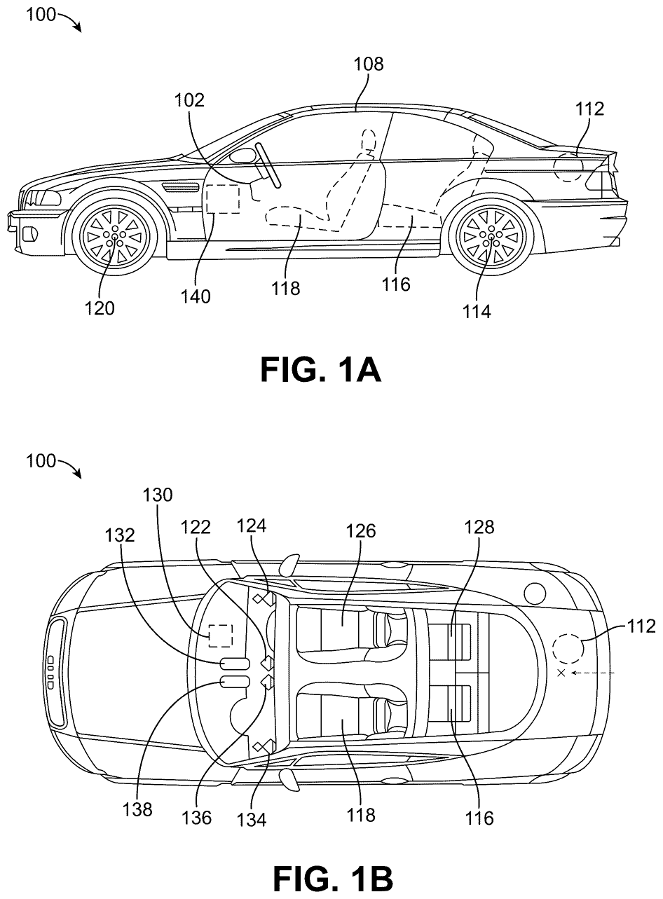

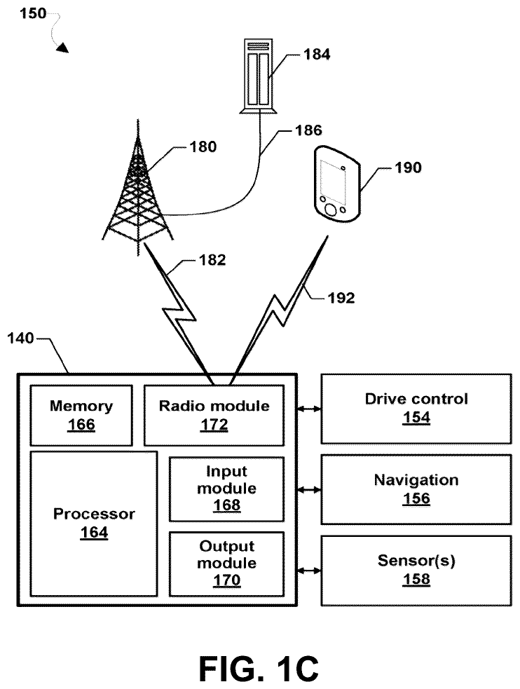

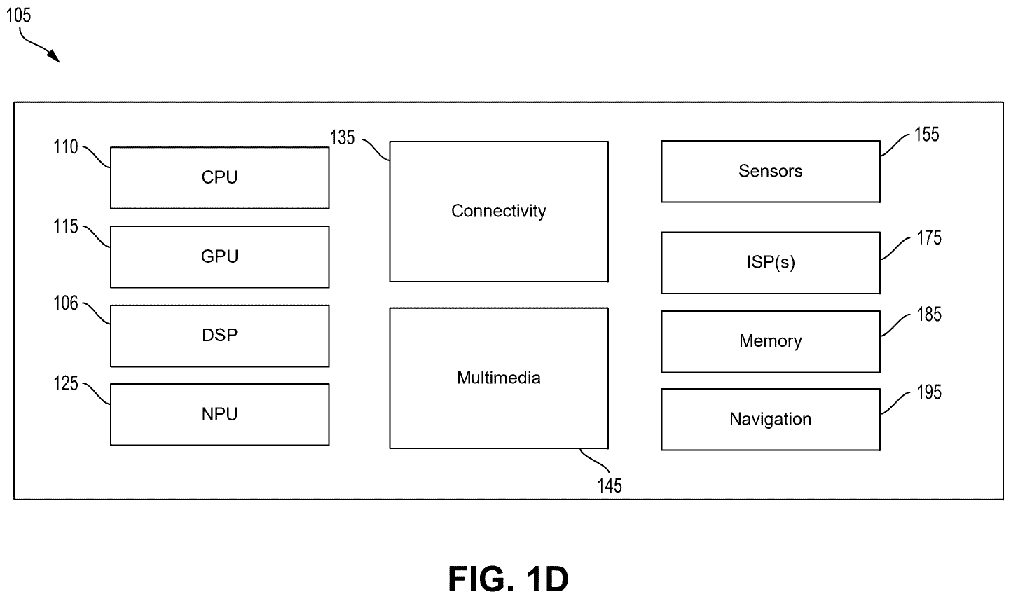

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various aspects using information received from various sensors, particularly the cameras 122, 136, radar 132, and LIDAR 138. In some aspects, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various aspects.

FIG. 1C is a component block diagram illustrating a system 150 of components and support systems suitable for implementing various aspects. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various aspects. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some aspects, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various aspects, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described and may be configured to provide a variety of data to the processor 164 and/or the navigation components 156. For example, the control unit 140 may aggregate and/or process data from the sensors 158 to produce information the navigation components 156 may use for localization. As a more specific example, the control unit 140 may process images from multiple camera sensors to generate a single semantically segmented image for the navigation components 156. As another example, the control unit 140 may generate a fused point clouds from LIDAR and radar data for the navigation components 156.

While the control unit 140 is described as including separate components, in some aspects some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various aspects when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

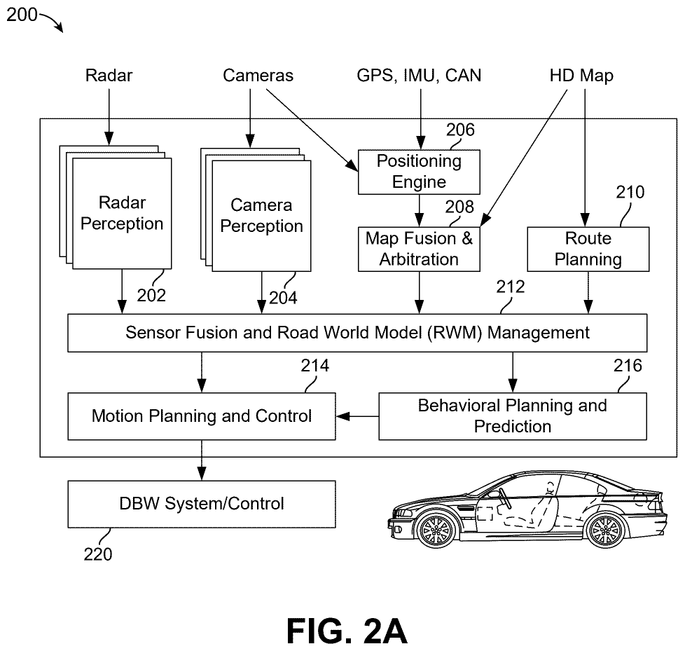

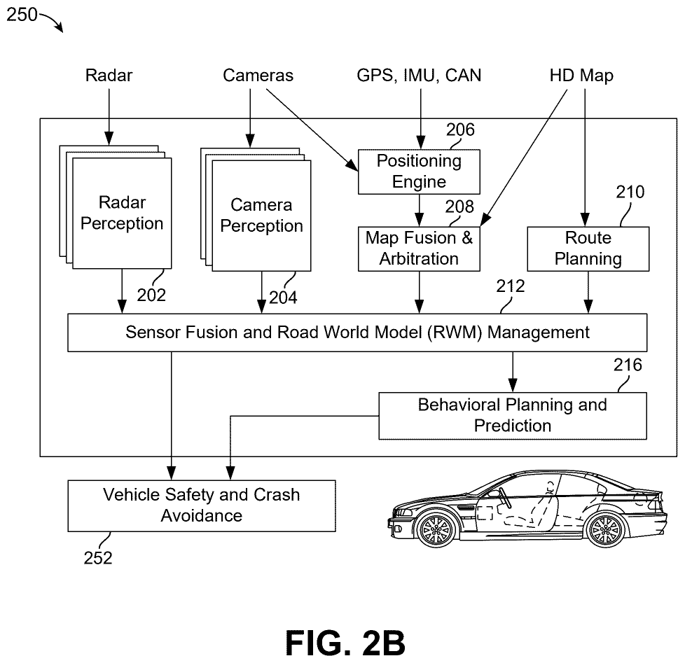

FIG. 2A illustrates an example of vehicle applications, subsystems, computational elements, or units within a vehicle management system 200, which may be utilized within a vehicle, such as vehicle 100 of FIG. 1A. With reference to FIGS. 1A-2A, in some aspects, the various vehicle applications, computational elements, or units within vehicle management system 200 may be implemented within a system of interconnected computing devices (i.e., subsystems), that communicate data and commands to each other. In other aspects, the vehicle management system 200 may be implemented as a plurality of vehicle applications executing within a single computing device, such as separate threads, processes, algorithms, or computational elements. However, the use of the term vehicle applications in describing various aspects are not intended to imply or require that the corresponding functionality is implemented within a single autonomous (or semi-autonomous) vehicle management system computing device, although that is a potential implementation aspect. Rather the use of the term vehicle applications is intended to encompass subsystems with independent processors, computational elements (e.g., threads, algorithms, subroutines, etc.) running in one or more computing devices, and combinations of subsystems and computational elements.

In various aspects, the vehicle applications executing in a vehicle management system 200 may include (but is not limited to) a radar perception vehicle application 202, a camera perception vehicle application 204, a positioning engine vehicle application 206, a map fusion and arbitration vehicle application 208, a route vehicle planning application 210, sensor fusion and road world model (RWM) management vehicle application 212, motion planning and control vehicle application 214, and behavioral planning and prediction vehicle application 216. The vehicle applications 202-216 are merely examples of some vehicle applications in one example configuration of the vehicle management system 200. In other configurations consistent with various aspects, other vehicle applications may be included, such as additional vehicle applications for other perception sensors (e.g., LIDAR perception layer, etc.), additional vehicle applications for planning and/or control, additional vehicle applications for modeling, etc., and/or certain of the vehicle applications 202-216 may be excluded from the vehicle management system 200. Each of the vehicle applications 202-216 may exchange data, computational results and commands.

The vehicle management system 200 may receive and process data from sensors (e.g., radar, LIDAR, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system 200 may output vehicle control commands or signals to the drive by wire (DBW) system/control unit 220, which is a system, subsystem or computing device that interfaces directly with vehicle steering, throttle and brake controls. The configuration of the vehicle management system 200 and DBW system/control unit 220 illustrated in FIG. 2A is merely an example configuration and other configurations of a vehicle management system and other vehicle components may be used in the various aspects. As an example, the configuration of the vehicle management system 200 and DBW system/control unit 220 illustrated in FIG. 2A may be used in a vehicle configured for autonomous or semi-autonomous operation while a different configuration may be used in a non-autonomous vehicle.

The radar perception vehicle application 202 may receive data from one or more detection and ranging sensors, such as radar (e.g., 132) and/or LIDAR (e.g., 138), and process the data to recognize and determine locations of other vehicles and objects within a vicinity of the vehicle 100. The radar perception vehicle application 202 may include use of neural network processing and artificial intelligence methods to recognize objects and vehicles, and pass such information on to the sensor fusion and RWM management vehicle application 212.

The camera perception vehicle application 204 may receive data from one or more cameras, such as cameras (e.g., 122, 136), and process the data to recognize and determine locations of other vehicles and objects within a vicinity of the vehicle 100. The camera perception vehicle application 204 may include use of neural network processing and artificial intelligence methods to recognize objects and vehicles and pass such information on to the sensor fusion and RWM management vehicle application 212.

The positioning engine vehicle application 206 may receive data from various sensors and process the data to determine a position of the vehicle 100. The various sensors may include, but is not limited to, GPS sensor, an IMU, and/or other sensors connected via a CAN bus. The positioning engine vehicle application 206 may also utilize inputs from one or more cameras, such as cameras (e.g., 122, 136) and/or any other available sensor, such as radars, LIDARs, etc.

The map fusion and arbitration vehicle application 208 may access data within a high-definition (HD) map database and receive output received from the positioning engine vehicle application 206 and process the data to further determine the position of the vehicle 100 within the map, such as location within a lane of traffic, position within a street map, etc., using localization. The HD map database may be stored in a memory (e.g., memory 166). For example, the map fusion and arbitration vehicle application 208 may convert latitude and longitude information from GPS into locations within a surface map of roads contained in the HD map database. GPS position fixes include errors, so the map fusion and arbitration vehicle application 208 may function to determine a best guess location of the vehicle 100 within a roadway based upon an arbitration between the GPS coordinates and the HD map data. For example, while GPS coordinates may place the vehicle 100 near the middle of a two-lane road in the HD map, the map fusion and arbitration vehicle application 208 may determine from the direction of travel that the vehicle 100 is most likely aligned with the travel lane consistent with the direction of travel. The map fusion and arbitration vehicle application 208 may pass map-based location information to the sensor fusion and RWM management vehicle application 212.

The route planning vehicle application 210 may utilize the HD map, as well as inputs from an operator or dispatcher to plan a route to be followed by the vehicle 100 to a particular destination. The route planning vehicle application 210 may pass map-based location information to the sensor fusion and RWM management vehicle application 212. However, the use of a prior map by other vehicle applications, such as the sensor fusion and RWM management vehicle application 212, etc., is not required. For example, other stacks may operate and/or control the vehicle based on perceptual data alone without a provided map, constructing lanes, boundaries, and the notion of a local map as perceptual data is received.

The sensor fusion and RWM management vehicle application 212 may receive data and outputs produced by one or more of the radar perception vehicle application 202, camera perception vehicle application 204, map fusion and arbitration vehicle application 208, and route planning vehicle application 210, and use some or all of such inputs to estimate or refine the location and state of the vehicle 100 in relation to the road, other vehicles on the road, and other objects within a vicinity of the vehicle 100. For example, the sensor fusion and RWM management vehicle application 212 may combine imagery data from the camera perception vehicle application 204 with arbitrated map location information from the map fusion and arbitration vehicle application 208 to refine the determined position of the vehicle within a lane of traffic. As another example, the sensor fusion and RWM management vehicle application 212 may combine object recognition and imagery data from the camera perception vehicle application 204 with object detection and ranging data from the radar perception vehicle application 202 to determine and refine the relative position of other vehicles and objects in the vicinity of the vehicle. As another example, the sensor fusion and RWM management vehicle application 212 may receive information from vehicle-to-vehicle (V2V) communications (such as via the CAN bus) regarding other vehicle positions and directions of travel and combine that information with information from the radar perception vehicle application 202 and the camera perception vehicle application 204 to refine the locations and motions of other vehicles. The sensor fusion and RWM management vehicle application 212 may output refined location and state information of the vehicle 100, as well as refined location and state information of other vehicles and objects in the vicinity of the vehicle, to the motion planning and control vehicle application 214 and/or the behavior planning and prediction vehicle application 216.

As a further example, the sensor fusion and RWM management vehicle application 212 may use dynamic traffic control instructions directing the vehicle 100 to change speed, lane, direction of travel, or other navigational element(s), and combine that information with other received information to determine refined location and state information. The sensor fusion and RWM management vehicle application 212 may output the refined location and state information of the vehicle 100, as well as refined location and state information of other vehicles and objects in the vicinity of the vehicle 100, to the motion planning and control vehicle application 214, the behavior planning and prediction vehicle application 216 and/or devices remote from the vehicle 100, such as a data server, other vehicles, etc., via wireless communications, such as through C-V2X connections, other wireless connections, etc.

As a still further example, the sensor fusion and RWM management vehicle application 212 may monitor perception data from various sensors, such as perception data from a radar perception vehicle application 202, camera perception vehicle application 204, other perception vehicle application, etc., and/or data from one or more sensors themselves to analyze conditions in the vehicle sensor data. The sensor fusion and RWM management vehicle application 212 may be configured to detect conditions in the sensor data, such as sensor measurements being at, above, or below a threshold, certain types of sensor measurements occurring, etc., and may output the sensor data as part of the refined location and state information of the vehicle 100 provided to the behavior planning and prediction vehicle application 216 and/or devices remote from the vehicle 100, such as a data server, other vehicles, etc., via wireless communications, such as through C-V2X connections, other wireless connections, etc.

The refined location and state information may include vehicle descriptors associated with the vehicle 100 and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction vehicle application 216 of the autonomous vehicle system 200 may use the refined location and state information of the vehicle 100 and location and state information of other vehicles and objects output from the sensor fusion and RWM management vehicle application 212 to predict future behaviors of other vehicles and/or objects. For example, the behavioral planning and prediction vehicle application 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction vehicle application 216 may output other vehicle and object behavior and location predictions to the motion planning and control vehicle application 214.

Additionally, the behavior planning and prediction vehicle application 216 may use object behavior in combination with location predictions to plan and generate control signals for controlling the motion of the vehicle 100. For example, based on route planning information, refined location in the roadway information, and relative locations and motions of other vehicles, the behavior planning and prediction vehicle application 216 may determine that the vehicle 100 needs to change lanes and accelerate, such as to maintain or achieve minimum spacing from other vehicles, and/or prepare for a turn or exit. As a result, the behavior planning and prediction vehicle application 216 may calculate or otherwise determine a steering angle for the wheels and a change to the throttle setting to be commanded to the motion planning and control vehicle application 214 and DBW system/control unit 220 along with such various parameters necessary to effectuate such a lane change and acceleration. One such parameter may be a computed steering wheel command angle.

The motion planning and control vehicle application 214 may receive data and information outputs from the sensor fusion and RWM management vehicle application 212 and other vehicle and object behavior as well as location predictions from the behavior planning and prediction vehicle application 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control vehicle application 214 may verify and pass various control commands or instructions to the DBW system/control unit 220.

The DBW system/control unit 220 may receive the commands or instructions from the motion planning and control vehicle application 214 and translate such information into mechanical control signals for controlling wheel angle, brake, and throttle of the vehicle 100. For example, DBW system/control unit 220 may respond to the computed steering wheel command angle by sending corresponding control signals to the steering wheel controller.

In various aspects, the vehicle management system 200 may include functionality that performs safety checks or oversight of various commands, planning or other decisions of various vehicle applications that could impact vehicle and occupant safety. Such safety checks or oversight functionality may be implemented within a dedicated vehicle application or distributed among various vehicle applications and included as part of the functionality. In some aspects, a variety of safety parameters may be stored in memory, and the safety checks or oversight functionality may compare a determined value (e.g., relative spacing to a nearby vehicle, distance from the roadway centerline, etc.) to corresponding safety parameter(s) and may issue a warning or command if the safety parameter is or will be violated. For example, a safety or oversight function in the behavior planning and prediction vehicle application 216 (or in a separate vehicle application) may determine the current or future separate distance between another vehicle (as refined by the sensor fusion and RWM management vehicle application 212) and the vehicle 100 (e.g., based on the world model refined by the sensor fusion and RWM management vehicle application 212), compare that separation distance to a safe separation distance parameter stored in memory, and issue instructions to the motion planning and control vehicle application 214 to speed up, slow down or turn if the current or predicted separation distance violates the safe separation distance parameter. As another example, safety or oversight functionality in the motion planning and control vehicle application 214 (or a separate vehicle application) may compare a determined or commanded steering wheel command angle to a safe wheel angle limit or parameter and may issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of vehicle applications, subsystems, computational elements, or units within a vehicle management system 250, which may be utilized within a vehicle 100. With reference to FIGS. 1A-2B, in some aspects, the vehicle applications 202, 204, 206, 208, 210, 212, and 216 of the vehicle management system 200 may be similar to those described with reference to FIG. 2A and the vehicle management system 250 may operate similar to the vehicle management system 200, except that the vehicle management system 250 may pass various data or instructions to a vehicle safety and crash avoidance system 252 rather than the DBW system/control unit 220. For example, the configuration of the vehicle management system 250 and the vehicle safety and crash avoidance system 252 illustrated in FIG. 2B may be used in a non-autonomous vehicle.

In various aspects, the behavioral planning and prediction vehicle application 216 and/or sensor fusion and RWM management vehicle application 212 may output data to the vehicle safety and crash avoidance system 252. For example, the sensor fusion and RWM management vehicle application 212 may output sensor data as part of refined location and state information of the vehicle 100 provided to the vehicle safety and crash avoidance system 252. The vehicle safety and crash avoidance system 252 may use the refined location and state information of the vehicle 100 to make safety determinations relative to the vehicle 100 and/or occupants of the vehicle 100. As another example, the behavioral planning and prediction vehicle application 216 may output behavior models and/or predictions related to the motion of other vehicles to the vehicle safety and crash avoidance system 252. The vehicle safety and crash avoidance system 252 may use the behavior models and/or predictions related to the motion of other vehicles to make safety determinations relative to the vehicle 100 and/or occupants of the vehicle 100.

In various aspects, the vehicle safety and crash avoidance system 252 may include functionality that performs safety checks or oversight of various commands, planning, or other decisions of various vehicle applications, as well as human driver actions, that could impact vehicle and occupant safety. In some aspects, a variety of safety parameters may be stored in memory and the vehicle safety and crash avoidance system 252 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system 252 may determine the current or future separate distance between another vehicle (as refined by the sensor fusion and RWM management vehicle application 212) and the vehicle (e.g., based on the world model refined by the sensor fusion and RWM management vehicle application 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system 252 may compare a human driver's change in steering wheel angle to a safe wheel angle limit or parameter and may issue an override command and/or alarm in response to the steering wheel angle exceeding the safe wheel angle limit.

Systems that usefully (and in some cases autonomously or semi-autonomously) move through the environment, such as autonomous vehicles or semi-autonomous vehicles, need to be able to gather information (e.g., perceive) about the environment in which they operate. For instance, a vehicle may need to be aware of other vehicles, pedestrians, objects in the road, changes in the driving surfaces, etc. The vehicle may obtain this information about the environment using perception systems. The perception systems may receive information from various sensors of the vehicle and the perception systems may process this received information to obtain the information about the environment. As an example, a perception system may include a set of ML models that may process images of the environment to perform various tasks, such as object detection, object classification, depth estimation, sign recognition, path finding, and so forth. In some cases, the perception system may include an ensemble of one or more ML models to perform different tasks and each task may have their own ensemble of one or more ML models to perform the task.

In some cases, the perception system may also include a security system which may perform certain security tasks, such as attempting to detect different potential attacks in the obtained sensor data. Different security tasks may be performed using different ensembles of one or more ML models. The security system and security tasks may run in parallel with perception tasks of the perception system.

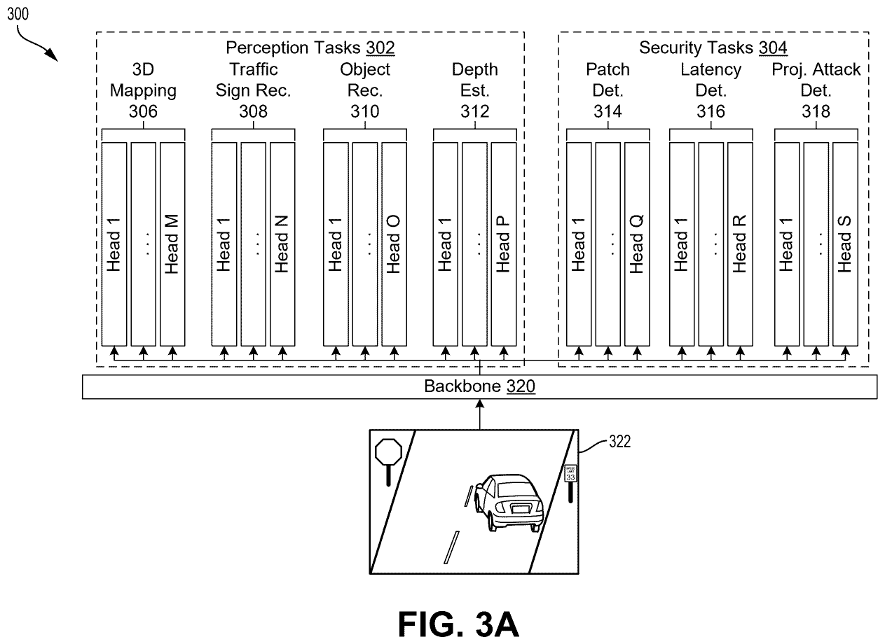

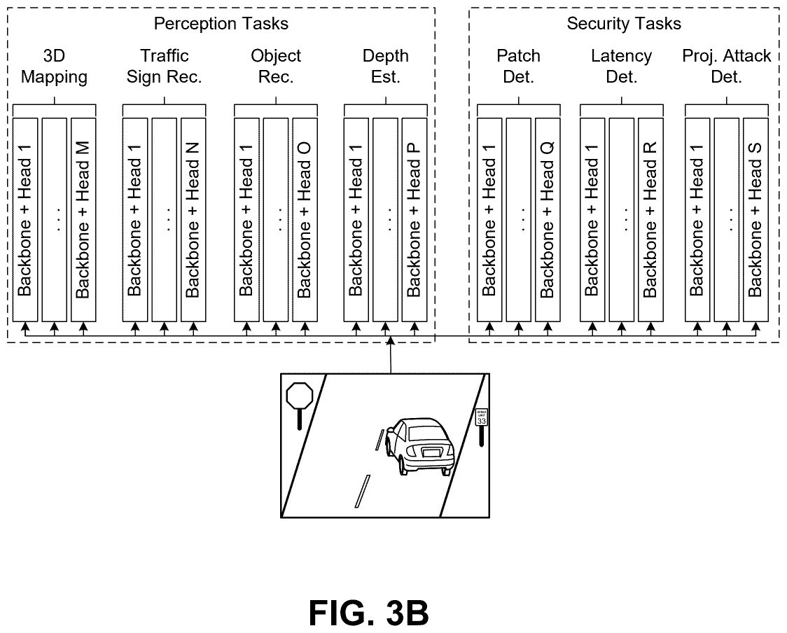

FIG. 3A is a block diagram illustrating a perception system 300 of an ADAS system, in accordance with aspects of the present disclosure. In some cases, the perception system 300 may be included as a part of a camera perception vehicle application 204 of FIG. 2A and 2B. The perception system 300 may perform both perception tasks 302 and security tasks 304, and the perception tasks 302 and security tasks 304 may operate in parallel. The perception tasks 302 may include those tasks which allow the perception system 300 to gather and process information about the environment. Examples of perception tasks 302 may include 3D mapping 306, traffic sign recognition 308, object recognition 310, and depth estimation 312.

A system that is not in a strictly controlled environment may be subject to attack from malicious actors. For instance, one or more attacks may target the perception system 300 through information obtained by the sensors of a vehicle. Example attacks on the perception system 300 may include projection attacks (e.g., where various signs, objects, patterns, etc. may be projected onto a surface on or near where a vehicle is travelling or directly onto a camera sensor of the vehicle, etc.), false signs (e.g., pedestrian with a stop sign shirt on, car with a yield sign, etc.), patch attacks (e.g., abstract patterns or false objects designed to fool image processing systems, radar/lidar reflectors/absorbers to confuse such sensors, etc.), and the like. Security tasks 304 include tasks to detect and/or mitigate attacks against and/or anomalies in the perception system 300. Examples of security tasks 304 may include patch detection 314, latency detection 316, and projection attack detection 318. It should be understood that these perception and security tasks shown in FIGS. 3A and 3B are examples and not intended to limit the tasks that may be performed by other perception system implementations.

In FIG. 3A, the tasks may be performed by ensembles (sets) of ML models (e.g., each task may be performed by one or more ML models). For example, the 3D mapping 306 task may be performed by an ensemble of ML model heads 1 . . . M, the traffic sign recognition 308 task may be performed by an ensemble of ML model heads 1 . . . N, and so forth. In some cases, a ML model may include a backbone and a head. Each ML model head may be one or more ML networks, such as such as deep convolutional networks (DCNs), convolutional neural networks (CNNs), etc. which may receive data from a common ML backbone 320 to perform a task. Multiple ML model heads (e.g., ML models) of an ensemble may all perform a particular task. For example, ML model heads 1 . . . M may form an ensemble of ML models for performing the 3D mapping 306 task. In some cases, the individual ML model heads of an ensemble may perform the same task differently. For example, ML model head 1 for the 3D mapping 306 task may be designed to perform 3D mapping in a city environment at a relatively low vehicle speed as compared to ML model head M for the 3D mapping 306 task, which is designed to perform 3D mapping on an open highway at a relatively high vehicle speed. In some cases, an ensemble of ML models may be used to perform a single task as multiple ML models provide redundancy, allows for cross checking across the multiple ML models (e.g., a primary ML model, secondary ML model, fusion of results between different ML models, etc.), allows for different ML models to be used in different conditions (e.g., different ML models as the primary ML model depending on conditions), allows for complementary ML models, etc. In some cases, a perception ensemble of one or more ML models may perform a perception task, such as 3D mapping 306. Similarly, a security ensemble of one or more ML models may perform a security task, such as patch detection 314.

In the perception system 300, the ML model heads share a common ML backbone 320. The ML backbone 320 may be one or more ML networks, such as such as deep convolutional networks (DCNs), convolutional neural networks (CNNs), etc. which may be incorporated into more complex ML networks. For example, the ML backbone 320 may be a DCN trained to extract and/or identify features from images 322 passed into the ML backbone 320. The extracted/identified features may be output from the ML backbone 320 into the ML model heads.

In some cases, as shown in FIG. 3B, rather than having a common ML backbone, each ML model may include a separate backbone and head. In other cases, a subset of the ML models may include a common backbone, while other ML models may include a backbone and head.

As indicated above, the perception system 300 may include multiple ML models that may execute concurrently. Generally, the perception system 300 has a finite amount of computing resources, and these computing resources may be divided at least in part between the perception tasks 302 and security tasks 304. In some cases, a resources manager for a secured ADAS perception system may be useful for managing and/or allocating limited computing resources with respect to the ensembles performing perception tasks and those ensembles performing security tasks.

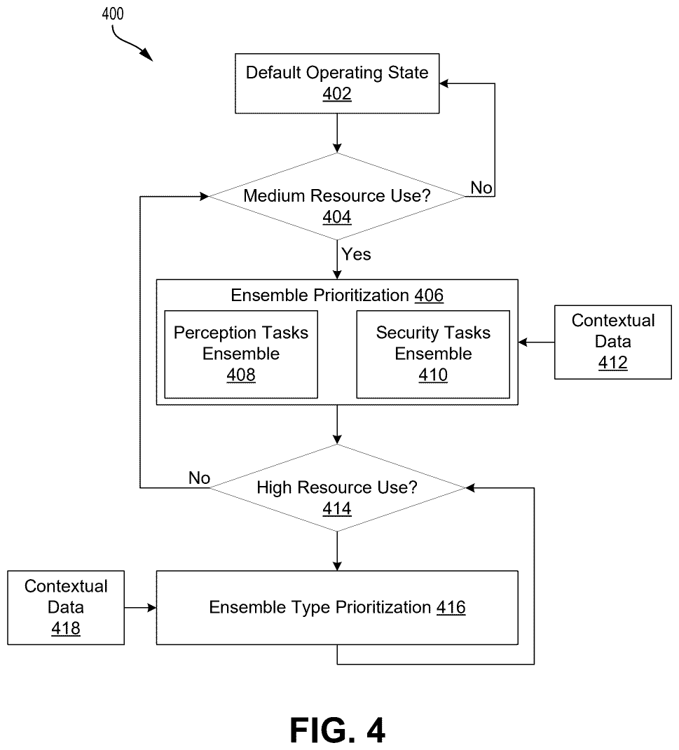

FIG. 4 is a flow diagram illustrating a technique for resources management 400 for a perception system, in accordance with aspects of the present disclosure. In FIG. 4, a perception system may initially be operating in a default operating state 402. In the default operating state 402, the perception system may not be managing computing resources as each ML model has sufficient computing resources to operate normally. The perception system may include a resources manager that may monitor the computing resources used by the perception system. For example, the resources manager may monitor each ML model usage of one or more computing resources and/or an overall usage of each computing resource.

In some cases, certain ML models and/or ensembles of ML models may use more computing resources than usual. For example, where a vehicle is operating in adverse conditions, such as in a severe weather, an area with a high road object density, etc., the perception ML models may use more computing resources to perform their tasks. Similarly, when an attack against the perception system has been detected/is occurring, the security ML models may use more computing resources to perform their tasks.

In cases where the resource manager does not detect that a medium threshold amount of computing resources is being used 404, the resources manager may remain in the default operating state 402. In some cases, if the resources manager detects that a medium threshold amount of a computing resource is being used, the resources manager may determine that there is a medium amount of resource usage and perform ensemble prioritization 406. In some cases, the medium threshold amount for each computing resource may be set on a system-by-system basis based on expert offline knowledge, for example, of an expected amount of computational resources typically used by the perception system, rates at which computational resources may change, total available computational resources, etc. In some cases, the medium threshold amount may be set before actual computational resources use becomes limiting as attempting to reallocate computational resources while computational resources are limited may be difficult.

Based on the determination that there is a medium amount of computing resource usage 404, the resources manager may perform ensemble prioritization 406. In ensemble prioritization 406, resources for ensembles may be managed. For example, the resource manager may manage the computational resources for the ensembles performing perception tasks 408 and the computational resources for ensembles performing security tasks 410 based on contextual data 412. The contextual data may be any data that may provide a context, that is data that may be used to determine what ML models may be more relevant. This data may be provided from any source, such as sensor data, data from a network/other vehicles, information from the ML models themselves, etc.

In some cases, managing the resources for ensamples can be performed by managing ensemble(s) of the ensembles for performing security tasks 410, manage or by managing ML models within an ensemble. Of note, a resources manager may manage ensemble(s), manage ML models within an ensemble, or concurrently mange ensemble(s) and manage ML models of an ensemble. While discussed with respect to managing resources for performing security tasks 410, it should be understood that the techniques discussed herein may also be applied to managing resources for ensembles performing perception tasks 408.

Managing ensemble(s) of the ensembles for performing security tasks 410 may be performed by attempting minimize a number of less relevant ensembles and maintaining operation of ensembles that are more relevant. Whether an ensemble is more or less relevant may be determined based on whether the ensemble is relevant to an attack, or an importance of an attack the ensemble is intended to detect/counter. Whether an ensemble is relevant to an attack may be determined based on whether an ensemble can detect and/or mitigate the attack. Thus, the contextual data 412 in this scenario may be whether ML models of an ensemble can detect/mitigate the attack. For example, if an attack is detected, all of the ensembles of ML models may be triggered in an attempt to determine a scope of the attack. In this example, the ensemble of ML models for detecting a patch attack (e.g., ensemble of ML models for performing the patch detection 314 task of FIG. 3A) may detect the patch attack. However, other ensembles, such as those for latency detection (e.g., latency detection 316 task of FIG. 3A), projection attack detection (e.g., projection attack detection 318 task of FIG. 3A), may not detect the patch attack (or may be producing results that are not useable, have become unresponsive, etc.) and thus these other ensembles may be less relevant to the attack as compared to ensemble(s) which detect the patch attack. In such cases the less relevant ensembles may be deactivated (e.g., all of the ML models of an ensemble may be disabled). In other cases, less than all of the ML models of a less relevant ensemble may be deactivated. For example, all of the ML models of the less relevant ensembles, except one ML model (e.g., a primary ML model), may be deactivated. The more relevant ensembles may continue to operate (e.g., are not disabled). In some cases, the one ML model that may not be deactivated may be predetermined.

In some cases, whether an ensemble is more or less relevant may be based on an importance of an attack the ensemble is intended to detect/counter. In some cases, attacks which may be more important (e.g., more relevant) may be those attacks that may be more dangerous for the perception system. As a more specific example, a denial of service attack may be more dangerous from a security perspective to the perception system as compared to a patch attack or misclassification type attack as the attack may cause the perception system to operate slowly. Exactly which attacks are more dangerous for the perception system may be predetermined, for example, based on expert analysis and/or policy. As discussed above, less relevant ensembles may be deactivated (e.g., all of the ML models of an ensemble may be disabled), or a number of ML models of the less relevant ensemble may be deactivated (e.g., all of the ML models of the less relevant ensembles are deactivated, except for one. The more relevant ensembles may continue to operate (e.g., are not disabled).

In other cases, attacks which may be more important may be those attacks which may have a safety impact. For example, a projection attack or patch attack may cause the vehicle containing the perception system to crash and/or hit an object and may be more important than a denial of service attack. Exactly which attacks may have a safety impact may be predetermined, for example, based on expert analysis and/or policy. As discussed above, less relevant ensembles may be deactivated (e.g., all of the ML models of an ensemble may be disabled), or a number of ML models of the less relevant ensemble may be deactivated (e.g., all of the ML models of the less relevant ensembles are deactivated, except for one. The more relevant ensembles may continue to operate (e.g., are not disabled).

As indicated above, in some cases, ML models of ensembles (e.g., within an ensemble) may be managed as a part of ensemble prioritization 406 to manage the computing resources for the ensembles. Managing the ML models of ensembles may be performed, for example, based on a ML model's relevance, an ML model's energy consumption, and an amount of time inference is taking for an ML model. In some cases, managing ML models within an ensemble based on relevance may differ from managing ensemble(s) based on relevance. For example, managing ML models within an ensemble based on relevance may ack on a ML model basis and seeks to keep ML models able to detect an attack (e.g., are relevant) enabled, while disabling ML models that are not able to detect an attack (e.g., are not relevant). In some cases, while all of the ML models of an ensemble of ML models may perform the same task, not all ML models of the ensemble may perform the task in the same way. For example, there may be different sub-categories of patch attacks (e.g., flavors), and some ML models of an ensemble of ML models to detect patch attacks may be more efficient than other ML models of the ensemble at detecting some sub-categories of patch attacks. In some cases, sub-categories of patch attacks may be defined based on properties of the attack, such as a noise (e.g., optical pattern) used to perform the attack, a shape of an attacked area, a size of the attacked area, etc. Generally, all of ML models of an ensemble of ML to detect an attack, such as a patch attack may be active when the attack is detected. After the attack has been detected, it may be useful to keep the ML models that detected the attack active. Similarly, it may be useful to disable ML models that are not able to detect the active attack. In some cases, determining which ML models to keep active and which ML models to disable may be determined based on certain independent conditions. These conditions may include how well the model operates to detect certain attacks (e.g., an expected detection rate) and whether there is a majority of models which can detect a particular attack. For example, if a model has a 98% detection rate based on experiments, as opposed to another one which has a 92% detection rate, the model with the higher detection rate may be kept active.

In some cases, ML models with at least a threshold detection rate, of an ensemble, may be kept active while other models of the ensemble may be disabled. This threshold detection rate may vary based on, for example, intensity of the attack, the sub-category of the attack, whether there are adverse environmental conditions, etc. In some cases, whether there are adverse environmental conditions may be based on contextual data 412, such as thermometer readings, analysis of captured images, information from a network or other vehicles, etc. Examples of adverse environmental conditions may include sun glare, rain, snow, etc. Where there are adverse environmental conditions, the ML models least influenced by the adverse environmental conditions may be kept active.

In some cases, the ML models of ensamples may be managed as a part of ensemble prioritization 406 based on an ML model's energy consumption. For example, ML models which consume too much energy (e.g., processing power) may be deactivated. ML models which consume too much energy may be ML models which may be subject to an attack, such as a denial of service attack, or latency attack. In some cases, ML models which are consuming energy above a certain threshold may be disabled. This threshold may be set per ML model, for example, based on experimentation (e.g., known worst case performance). In some cases, the value of this threshold may vary based on contextual data 412, such as a geographical area the vehicle is in (e.g., urban, rural, highway, etc.), traffic density, time of day, etc. In other cases, ML models may be disabled based on a number of objects expected around the vehicle. For example, a certain ML model may function well with a lower number of objects, but cease to be efficient/effective above a certain number of objects. The number of objects for a given ML model after which the ML model may be disabled may vary on a per ML model basis (and some ML models may have no limit based on the number of objects) and may be determined based on experimentation. The specific number of objects after which a ML model may be disabled may also vary based on contextual data 412, such as a geographical area the vehicle is in (e.g., urban, rural, highway, etc.), traffic density, time of day, etc.

In some cases, the ML models of ensamples may be managed as a part of ensemble prioritization 406 based on an amount of time inference is taking for an ML model. For example, ML models which are taking too long to perform one or more inferences may be deactivated. ML models which take too long to perform one or more inferences, as with ML models with an energy consumption that is too high may be subject to an attack, such as a denial of service attack, or latency attack. In some cases, ML models with an inference time above a certain threshold may be disabled. This threshold may be set per ML model, for example, based on experimentation (e.g., known worst case performance). In some cases, the value of this threshold may vary based on contextual data 412, such as a geographical area the vehicle is in (e.g., urban, rural, highway, etc.), traffic density, time of day, etc. In other cases, ML models may be disabled based on a number of objects expected around the vehicle. For example, a certain ML model may function well with a lower number of objects, but inference time with these ML models may increase to unacceptable levels above a certain number of objects. The number of objects for a given ML model after which the ML model may be disabled may vary on a per ML model basis (and some ML models may have no limit based on the number of objects) and may be determined based on experimentation. The specific number of objects after which a ML model may be disabled may also vary based on contextual data 412, such as a geographical area the vehicle is in (e.g., urban, rural, highway, etc.), traffic density, time of day, etc.

In some cases, the resource manager may monitor for a high threshold amount of computing resources being used 414. For example, where ensemble type prioritization 406 is being performed, the resource manager may continue to monitor computing resource usage. If the resource manager does not detect that a high threshold amount of computing resources is being used 414, ensemble type prioritization 406 may continue until computing resource usage falls below the medium threshold amount of computing resource usage 404 and fall back to the default operating state 402.

If the resource manager detects a high threshold amount of computing resources being used 414, ensemble type prioritization 416 may be performed. The high threshold amount of computing resources may be reached when more computing resources is used as compared to the medium threshold amount of computing resources. In some cases, the high threshold amount for each computing resource may be set on a system-by-system basis based on expert offline knowledge, for example, of an expected amount of computational resources typically used by the perception system, rates at which computational resources may change, total available computational resources, etc. In some cases, the high threshold amount may be set before actual computational resources use becomes limiting as attempting to reallocate computational resources while computational resources are limited may be difficult.

Based on the determination that there is a high amount of resource usage 414, the resources manager may perform ensemble type prioritization 416. In ensemble type prioritization, certain types of ensembles may be prioritized over other types of ensembles. For example, ensembles for performing perception tasks may be prioritized over ensamples for performing security tasks to reduce a number of ensembles/ML models operating. As another example, ensembles for performing security tasks may be prioritized over ensamples for performing perception tasks to reduce a number of ensembles/ML models operating. In yet another example, a compromise between ensembles for performing perception tasks and ensembles for performing security tasks may be reached to reduce a number of ensembles/ML models operating. In some cases, ensemble type prioritization may adjust which ensemble type is prioritized based on use cases.

One use case for ensemble type prioritization 416 may include when a vehicle is operating in a challenging functional environment (e.g., perceptive environment). A challenging functional environment may be detected based on contextual data 418, that may be obtained for ensemble type prioritization 416. In some cases, contextual data 418 may be substantially similar to contextual data 412. The presence of a challenging functional environment may be detected when the vehicle is operating in a challenging road scenario, such as where the speed of the vehicle is below a certain threshold (e.g., in a traffic jam), where a number of detected objects around the vehicle is above a first threshold (e.g., high density of road objects), or if there are severe environmental conditions (e.g., snow, heavy rain, other severe weather). In some cases, challenging functional environment may include when the vehicle is operating with limited energy (e.g., battery power, fuel, etc.) to reach a destination. Examples of when the vehicle may be operating with limited energy to reach a destination may include where the level of energy available to the vehicle is below a reserve margin (or insufficient) to reach the destination, where the remaining distance to reach the destination is too high, where the remaining time to reach the destination is too high, where the energy to reach the destination is too high taking into account a worst case energy usage scenario for one or more ML models/ensembles, when taking into account expected traffic conditions or expected weather conditions, etc.

In a challenging functional environment, ensembles performing perception tasks may be prioritized over ensembles performing security tasks. In some cases, to prioritize perception tasks ensembles, all of the ML models in an ensemble for the security tasks may be disabled except for one ML model (e.g., a predetermined primary ML model). In cases where additional resources are used by the ensembles performing perception tasks, all of the ML models in the ensembles for performing security tasks may be disabled. Whether additional resources are used by the ensembles performing perception tasks may be determined based on predetermined thresholds of available computing resources or energy consumption levels of ensembles performing perception tasks.

Another use case for ensemble type prioritization 416 may include when a vehicle is operating in a challenging security environment. A challenging security environment may be detected based on contextual data 418, such as data obtained by the security ML models. For example, the challenging security environment use case may arise when there may be several types of attacks at once. For example, that there may be several types of attacks at once may be determined if a threshold number of security ensembles detect attacks. This threshold number of security ensembles may be predetermined based on expert knowledge and/or experimentation. Similarly, that there may be several types of attacks at once may be determined if a sum energy used by the security ensembles rises above a threshold energy use. This threshold energy use may also be predetermined based on expert knowledge and/or experimentation. In some cases, a determination that where there may be several types of attacks occurring at once may be determined based on, for example, whether a total amount of memory used by the security ensembles rises above a threshold memory usage level. This threshold memory usage level may also be predetermined based on expert knowledge and/or experimentation.

As another example, the challenging security environment use case may arise where there are several instances of an attack. In some cases, a determination that there are several instances of an attack may be made if multiple attacks are initially detected. In some cases, in a manner similar to detecting multiple attacks, the determination that there are several instances of an attack may be made if a sum energy used by the security ensembles rises above a threshold energy use, or if a total amount of memory used by the security ensembles rises above a threshold memory usage level.

In a challenging security environment, ensembles performing security tasks may be prioritized over ensembles performing perception tasks. In some cases, to prioritize security tasks ensembles, all of the ML models in an ensemble for the perception tasks may be disabled except for one ML model (e.g., a predetermined primary ML model, such as one with a highest detection rate). In cases where additional resources are used by the ensembles performing security tasks, less relevant perception ML models/ensembles may be disabled. In some cases, less relevant perception ML models/ensembles may be determined based on mapping information. For example, based on an expected location of the vehicle, a determination that the vehicle will not encounter certain signs and/or traffic lights may be made. Based on this determination ML models/ensembles for detecting/recognizing certain signs and/or traffic lights may be disabled.

In some cases, a compromise between ensembles for performing perception tasks and ensembles for performing security tasks may be reached to reduce a number of ensembles/ML models operating for ensemble type prioritization. Where a compromise between perception task ensembles and security task ensembles is established, ensembles and/or ML models which are currently relevant may be kept active and other ensembles/ML models disabled. For example, if there are traffic lights being detected or attacks being detected, the ensembles/ML models that detect such events may be retained. Ensembles/ML models which are less relevant to a present situation may be disabled. For example, if there are currently no traffic signs/lights being detected, the ensembles/ML models for detecting traffic signs/lights may be temporarily disabled. Similarly, if there are no projection attacks being detected, then ensembles/ML models for detecting projection attacks may be disabled.

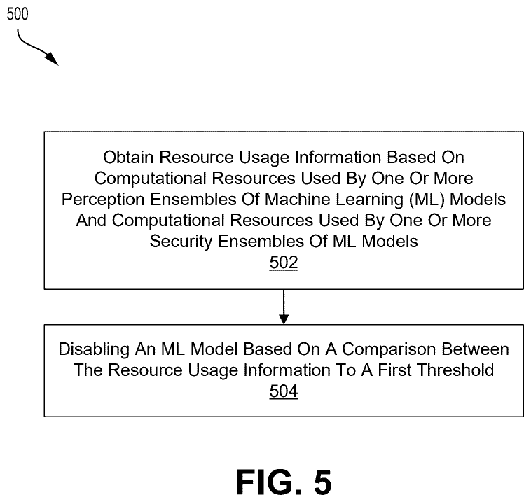

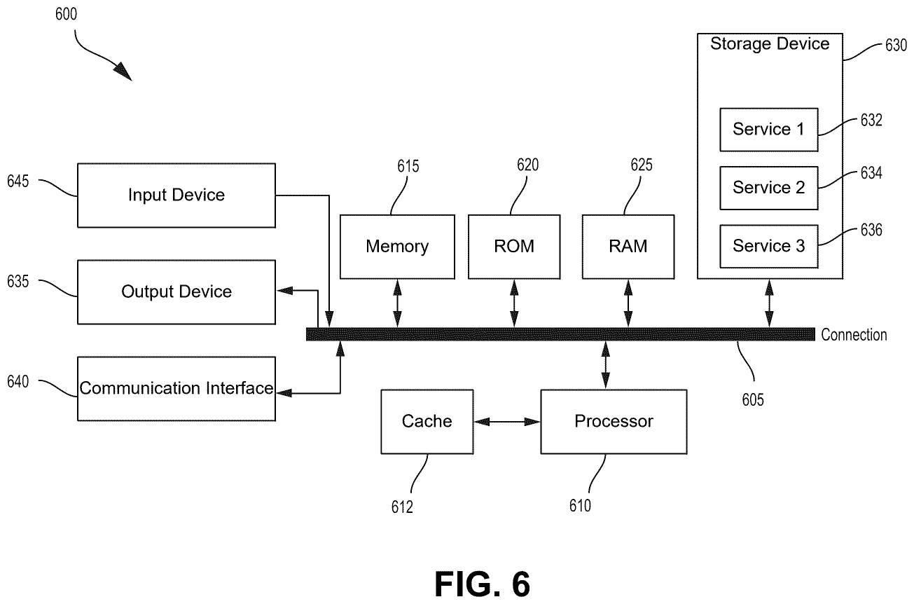

FIG. 5 is a flow diagram illustrating a process 500 for managing computing resources, in accordance with aspects of the present disclosure. The process 500 may be performed by a computing device (or apparatus) or a component (e.g., a chipset, codec, etc.) of the computing device. The computing device may be a mobile device (e.g., a vehicle, mobile phone, etc.), a network-connected wearable such as a watch, an extended reality (XR) device such as a virtual reality (VR) device or augmented reality (AR) device, a vehicle (e.g., vehicle 100 of FIG. 1A) or component or system of a vehicle (e.g., control unit 140 of FIG. 1A, SOC 105 of FIG. 1D, vehicle management system 200 of FIG. 2A, computing system 600 of FIG. 6, etc.), or other type of computing device. The operations of the process 500 may be implemented as software components that are executed and run on one or more processors (e.g., processor 164 of FIG. 1C, CPU 110, GPU 115, DSP 106, NPU 125 of FIG. 1D, processor 610 of FIG. 6, etc.).

At block 502, the computing device (or component thereof) may obtaining resource usage information based on computational resources used by one or more perception ensembles (e.g., ML model heads for performing the perception tasks 302) of machine learning (ML) models (e.g., ML model heads) and computational resources used by one or more security ensembles (e.g., ML model heads for performing the security tasks 304) of ML models. In some cases, computational resources may include available processing cycles, memory, storage, bandwidth, power consumption, thermal overhead, etc. In some examples, one or more ML models of the perception ensemble of ML models are configured to perform one or more perception tasks. Perception tasks may be any function that may be performed by a ML model that interprets sensor data to obtain information about the environment. In some cases, one or more ML models of a security ensemble of ML models are configured to perform one or more security tasks. Security tasks for the perception system may be functions performed by a ML model which may protect the operation of the perception system by detecting and/or mitigating attempts to manipulate, alter, deceive, or otherwise influence a normal operation of the perception system.

At block 504, the computing device (or component thereof) may disable the ML model based on a comparison between the resource usage information to a first threshold. In some cases, to disable the ML model, the computing device (or component thereof) may select the ML model of the one or more security ensembles of ML models based on at least one of: a relevance of the ensemble, or a priority of the ensemble; and disable one of: all of the ML models of the ensemble; or all but one of the ML models of the ensemble. In some cases, the priority of the ensemble is based on one of a safety impact of the ensemble or an attack (or multiple attacks) the ensemble is configured to detect. In some cases, to select the ML model of the one or more security ensembles of ML models, the computing device (or component thereof) may select the ML model from the one or more security ensembles of ML models based on at least one of: a relevance of the ML model; an energy consumption of the ML model; or an inference time of the ML model. In some examples, the relevance of the ML model is based on contextual data. In some cases, the computing device (or component thereof) may determine a resources usage indicated by the resource usage information exceeds a second threshold; obtain contextual data indicating presence of a challenging functional environment or a challenging security environment; and determine whether to prioritize the one or more perception ensembles of ML models or the one or more security ensembles of ML models based on the contextual data. Contextual data may be any data that may be used to determine what ML models may be more relevant and this data may be provided from any source, such as sensor data, data from a network/other vehicles, information from the ML models themselves, etc. In some examples, the contextual data indicates the presence of a challenging security environment based on an indication that an attack is occurring. In some cases, the contextual data indicates the presence of a challenging functional environment based on at least one of a condition of an environment around a vehicle or an amount of battery power available to the vehicle. In some examples, the computing device (or component thereof) may disable one or more security ML models based on the indicated presence of the challenging functional environment. In some cases, the computing device (or component thereof) may determine that an attack is occurring based on at least one of: at least a first threshold number of attacks have been detected; at least a second threshold number of security ensembles of ML models have detected attacks; a third threshold amount of memory is being used by the security ensembles of ML models; or a fourth threshold amount of energy is being used by the security ensembles of ML models.

In some examples, the processes described herein (e.g., process 500 and/or other process described herein) may be performed by the vehicle 100 of FIG. 1A.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 500 and/or other processes described herein may include a processor, microprocessor, micro-computer, or other component of a device that is configured to carry out the steps of the process 500 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 500 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 500 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 500 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some embodiments, computing system 600 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some embodiments, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method for managing computing resources, comprising: obtaining resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and disabling the ML model based on a comparison between the resource usage information to a first threshold.

Aspect 2. The method of Aspect 1, wherein disabling the ML model comprises: selecting the ML model of the one or more security ensembles of ML models based on at least one of: a relevance of the ensemble, or a priority of the ensemble; and disabling one of: all of the ML models of the ensemble; or all but one of the ML models of the ensemble.

Aspect 3. The method of Aspect 2, wherein the priority of the ensemble is based on one of a safety impact of the ensemble or an attack the ensemble is configured to detect.

Aspect 4. The method of any of Aspects 2-3, wherein selecting the ML model of the one or more security ensembles of ML models comprises selecting the ML model from the one or more security ensembles of ML models based on at least one of: a relevance of the ML model; an energy consumption of the ML model; or an inference time of the ML model.

Aspect 5. The method of Aspect 4, wherein the relevance of the ML model is based on contextual data.

Aspect 6. The method of any of Aspects 1-5, further comprising: determining a resources usage indicated by the resource usage information exceeds a second threshold; obtaining contextual data indicating presence of a challenging functional environment or a challenging security environment; and determining whether to prioritize the one or more perception ensembles of ML models or the one or more security ensembles of ML models based on the contextual data.

Aspect 7. The method of Aspect 6, wherein the contextual data indicates the presence of a challenging security environment based on an indication that an attack is occurring.

Aspect 8. The method of any of Aspects 6-7, wherein the contextual data indicates the presence of a challenging functional environment based on at least one of a condition of an environment around a vehicle or an amount of battery power available to the vehicle.

Aspect 9. The method of Aspect 8, further comprising disabling one or more security ML models based on the indicated presence of the challenging functional environment.

Aspect 10. The method of Aspect 9, wherein the indication that an attack is occurring comprises determining at least one of: at least a first threshold number of attacks have been detected; at least a second threshold number of security ensembles of ML models have detected attacks; a third threshold amount of memory is being used by the security ensembles of ML models; or a fourth threshold amount of energy is being used by the security ensembles of ML models.

Aspect 11. An apparatus for managing computing resources, comprising: a memory system comprising instructions; and a processor system coupled to the memory system, wherein the processor system is configured to: obtain resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and disable the ML model based on a comparison between the resource usage information to a first threshold.

Aspect 12. The apparatus of Aspect 11, wherein, to disable the ML model, the processor system is configured to: select the ML model of the one or more security ensembles of ML models based on at least one of: a relevance of the ensemble, or a priority of the ensemble; and disable one of: all of the ML models of the ensemble; or all but one of the ML models of the ensemble.

Aspect 13. The apparatus of Aspect 12, wherein the priority of the ensemble is based on one of a safety impact of the ensemble or an attack the ensemble is configured to detect.

Aspect 14. The apparatus of any of Aspects 12-13, wherein, to selecting the ML model of the one or more security ensembles of ML models, the processor system is configured to select the ML model from the one or more security ensembles of ML models based on at least one of: a relevance of the ML model; an energy consumption of the ML model; or an inference time of the ML model.

Aspect 15. The apparatus of Aspect 14, wherein the relevance of the ML model is based on contextual data.

Aspect 16. The apparatus of any of Aspects 11-15, wherein the processor system is further configured to: determine a resources usage indicated by the resource usage information exceeds a second threshold; obtain contextual data indicating presence of a challenging functional environment or a challenging security environment; and determine whether to prioritize the one or more perception ensembles of ML models or the one or more security ensembles of ML models based on the contextual data.

Aspect 17. The apparatus of Aspect 16, wherein the contextual data indicates the presence of a challenging security environment based on an indication that an attack is occurring.

Aspect 18. The apparatus of any of Aspects 16-17, wherein the contextual data indicates the presence of a challenging functional environment based on at least one of a condition of an environment around a vehicle or an amount of battery power available to the vehicle.

Aspect 19. The apparatus of Aspect 18, further comprising disabling one or more security ML models based on the indicated presence of the challenging functional environment.

Aspect 20. The apparatus of Aspect 19, wherein the processor system is further configured to determine the indication that an attack is occurring based on at least one of: at least a first threshold number of attacks have been detected; at least a second threshold number of security ensembles of ML models have detected attacks; a third threshold amount of memory is being used by the security ensembles of ML models; or a fourth threshold amount of energy is being used by the security ensembles of ML models.

Aspect 21. A non-transitory computer-readable medium having stored thereon instructions that, when executed by a processor system, cause the processor system to perform operations according to any of Aspects 1 to 10.

Aspect 22: An apparatus for image processing, comprising one or more means for performing operations according to any of Aspects 1 to 10.

What is claimed is:

1. A method for managing computing resources, comprising:
obtaining resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and
disabling an ML model based on a comparison between the resource usage information to a first threshold.

2. The method of claim 1, wherein disabling the ML model comprises:
selecting the ML model from the security ensemble of ML models based on at least one of:
a relevance of the security ensemble of ML models, or
a priority of the security ensemble of ML models; and
disabling one of:
all of the ML models of the security ensemble of ML models; or
all but one of the ML models of the security ensemble of ML models.

3. The method of claim 2, wherein the priority of the security ensemble of ML models is based on one of a safety impact of the security ensemble of ML models or an attack the security ensemble of ML models is configured to detect.

4. The method of claim 2, wherein selecting the ML model from the security ensemble of ML models comprises selecting the ML model from the security ensemble of ML models based on at least one of:
a relevance of the ML model;
an energy consumption of the ML model; or
an inference time of the ML model.

5. The method of claim 4, wherein the relevance of the ML model is based on contextual data.

6. The method of claim 1, further comprising:
determining a resources usage indicated by the resource usage information exceeds a second threshold;
obtaining contextual data indicating presence of a challenging functional environment or a challenging security environment; and
determining whether to prioritize the one or more perception ensembles of ML models or the one or more security ensembles of ML models based on the contextual data.

7. The method of claim 6, wherein the contextual data indicates the presence of a challenging security environment based on an indication that an attack is occurring.

8. The method of claim 6, wherein the contextual data indicates the presence of a challenging functional environment based on at least one of a condition of an environment around a vehicle or an amount of battery power available to the vehicle.

9. The method of claim 8, further comprising disabling one or more security ML models based on the indicated presence of the challenging functional environment.

10. The method of claim 9, wherein the indication that an attack is occurring comprises determining at least one of:
at least a first threshold number of attacks have been detected;
at least a second threshold number of security ensembles of ML models have detected attacks;
a third threshold amount of memory is being used by the security ensemble of ML models; or
a fourth threshold amount of energy is being used by the security ensemble of ML models.

11. An apparatus for managing computing resources, comprising:
a memory system comprising instructions; and
a processor system coupled to the memory system, wherein the processor system is configured to:
obtain resource usage information based on computational resources used by one or more perception ensembles of machine learning (ML) models and computational resources used by one or more security ensembles of ML models, wherein one or more ML models of a functional ensemble of ML models are configured to perform one or more perception tasks, and wherein one or more ML models of a security ensemble of ML models are configured to perform one or more security tasks; and
disable an ML model based on a comparison between the resource usage information to a first threshold.

12. The apparatus of claim 11, wherein, to disable the ML model, the processor system is configured to:
select the ML model from the security ensemble of ML models based on at least one of:
a relevance of the security ensemble of ML models, or
a priority of the security ensemble of ML models; and
disable one of:
all of the ML models of the security ensemble of ML models; or
all but one of the ML models of the security ensemble of ML models.

13. The apparatus of claim 12, wherein the priority of the security ensemble of ML models is based on one of a safety impact of the security ensemble of ML models or an attack the security ensemble of ML models is configured to detect.

14. The apparatus of claim 12, wherein, to selecting the ML model from the security ensemble of ML models, the processor system is configured to select the ML model from the security ensemble of ML models based on at least one of:
a relevance of the ML model;
an energy consumption of the ML model; or
an inference time of the ML model.

15. The apparatus of claim 14, wherein the relevance of the ML model is based on contextual data.

16. The apparatus of claim 11, wherein the processor system is further configured to:
determine a resources usage indicated by the resource usage information exceeds a second threshold;
obtain contextual data indicating presence of a challenging functional environment or a challenging security environment; and
determine whether to prioritize the one or more perception ensembles of ML models or the one or more security ensembles of ML models based on the contextual data.

17. The apparatus of claim 16, wherein the contextual data indicates the presence of a challenging security environment based on an indication that an attack is occurring.

18. The apparatus of claim 16, wherein the contextual data indicates the presence of a challenging functional environment based on at least one of a condition of an environment around a vehicle or an amount of battery power available to the vehicle.

19. The apparatus of claim 18, further comprising disabling one or more security ML models based on the indicated presence of the challenging functional environment.

20. The apparatus of claim 19, wherein the processor system is further configured to determine the indication that an attack is occurring based on at least one of:
at least a first threshold number of attacks have been detected;
at least a second threshold number of security ensembles of ML models have detected attacks;
a third threshold amount of memory is being used by the security ensemble of ML models; or
a fourth threshold amount of energy is being used by the security ensemble of ML models.
